(19) United States
(12) Patent Application Publication
(10) Pub. No.: US 2010/0148694 A1
(43) Pub. Date: Jun. 17, 2010

(54) LED light string with capacitor based rectifier filter for increasing output voltage

(76) Inventors: Chu-Cheng Chang, Hsinchu City (TW); Cheng-Fen Chang, Hsinchu City (TW); Chen-Hsien Chang, Hsinchu City (TW); Chen-Tao Chang, Hsinchu City (TW)

Correspondence Address: BACON & THOMAS, PLLC, 625 SLATERS LANE, FOURTH FLOOR, ALEXANDRIA, VA, 22314-1176, US

(21) Appl. No.: 12/314,627

(22) Filed: Dec. 15, 2008

(51) Int. Cl. H05B 41/36

(52) U.S. Cl. 315/294

(57) ABSTRACT

A string of LED light is provided. The string of LED light has a full-wave rectifier with a capacitor based filter for increasing output voltage to the range of 2.6 to 2.84 times as compared with the output voltage of a typical full-wave rectifier without filter so that an increased number of lamps each having an LED and a Zener diode in parallel therewith can be attached to the string of LED light.

### BACKGROUND OF THE INVENTION

1. Field of Invention

The invention relates to providing electrical power to a plurality of low voltage electrical loads, and more particularly to a string of LED (light-emitting diode) light having a full-wave rectifier with a capacitor based filter for increasing output voltage so that an increased number of lamps can be attached to the string of LED light.

2. Description of Related Art

LEDs are renowned for their long life and their ability to resist shock. Also, an LED consumes much less electrical power than fluorescent lamps (i.e., energy saving). Therefore, LED lighting devices are gaining popularity worldwide.

A typical string of lights including a plurality of LED bulbs arranged electrically in a series circuit is shown in FIG. 1. AC (alternating current) 120V is rectified by a full-wave rectifier (e.g., bridge rectifier as shown) to convert into DC (direct current) to be consumed by the plurality of LED bulbs. However, the well known light string suffers from a disadvantage. In detail, one LED bulb of the string burning out will kill the circuit. For example, the light string comprises 40 blue LED bulbs of 3V 0.02 A. Any burned out blue LED bulb will kill the circuit with the remaining 39 blue LED bulbs being disabled.

Another typical string of lights including a plurality of (e.g., 35) white LED bulbs of 3.2V 0.02 A arranged electrically in a parallel circuit is shown in FIG. 2. It has the advantage of maintaining the circuit in a normal operation except all LED bulbs are burned out. That is, for example, one burned out LED bulb will not kill the circuit.

However, the well known light string still suffers from a disadvantage. In detail, electric current is required to increase as the number of LED bulbs increases. The total current (e.g., I) of the circuit can be expressed as a multiplication of current (e.g., If) flowing through each LED bulb times the number of LED bulbs (e.g., N). As shown, AC 120V is rectified by a full-wave rectifier 15 to convert into DC (e.g., DC 3.5V 0.7 A) to be consumed by the 35 white LED bulbs. For example, operating voltage of the white LED bulb is 3.2V and operating current thereof is 0.7 A. Hence, the total current (I) is 0.02 A×35 equal to 0.7 A. Advantageously, the circuit will maintain its normal operation if, for example, one white LED bulb is burned out. That is, the remaining 34 white LED bulbs still emit light. However, it is impossible of attaching at least 35 or even at least 60 LED bulbs to the light string. That is, the number of LED bulbs may be insufficient for some applications.

There have been numerous suggestions in prior patents for light string. For example, U.S. Pat. No. 6,344,716 discloses a Christmas light string. Thus, continuing improvements in the exploitation of light string employing LED bulbs are constantly being sought.

### SUMMARY OF THE INVENTION

It is therefore one object of the invention to provide a string of LED light having a full-wave rectifier with a capacitor based filter for increasing output voltage to the range of 2.6 to 2.84 times as compared with the output voltage of a full-wave rectifier without filter so that an increased number of lamps can be attached to the string of LED light.

The above and other objects, features and advantages of the invention will become apparent from the following detailed description taken with the accompanying drawings.

### BRIEF DESCRIPTION OF THE DRAWINGS

FIG. 1 is a circuit diagram of a typical LED light string with lamps arranged in series;

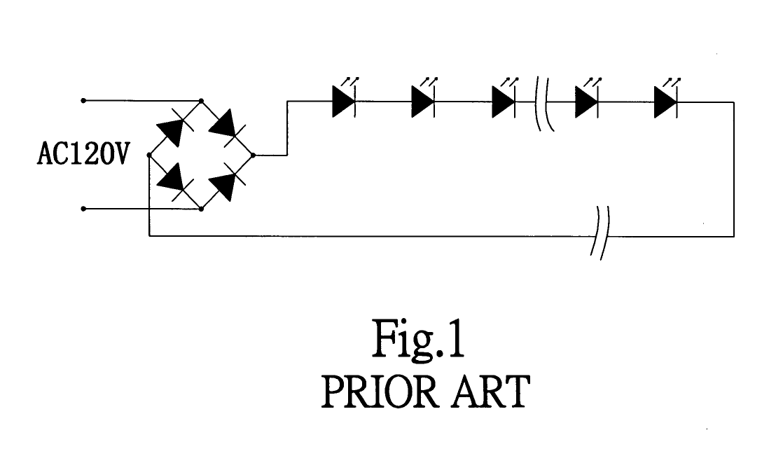

FIG. 2 is a circuit diagram of another typical LED light string with lamps arranged in parallel;

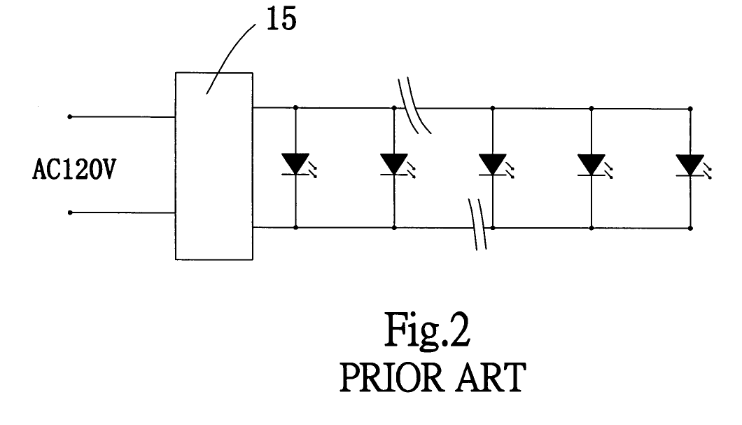

FIG. 3 is a schematic circuit diagram of a string of lights according to the invention;

FIG. 4 is a circuit diagram of a first preferred embodiment of rectifier according to the invention;

FIG. 5 is a circuit diagram of a second preferred embodiment of rectifier according to the invention;

FIG. 6 is an illustration of a first configuration of the string of lights of FIG. 3;

FIG. 7 is an illustration of a second configuration of the string of lights of FIG. 3;

FIG. 8 is an enlarged view of the lamp of FIG. 6 or FIG. 7;

FIG. 9 is a circuit diagram of the string of lights incorporating the first preferred embodiment of rectifier according to the invention;

FIG. 10 is a circuit diagram of the string of lights incorporating the second preferred embodiment of rectifier according to the invention; and

FIG. 11 is a schematic circuit diagram of another string of lights according to the invention.

### DETAILED DESCRIPTION OF THE INVENTION

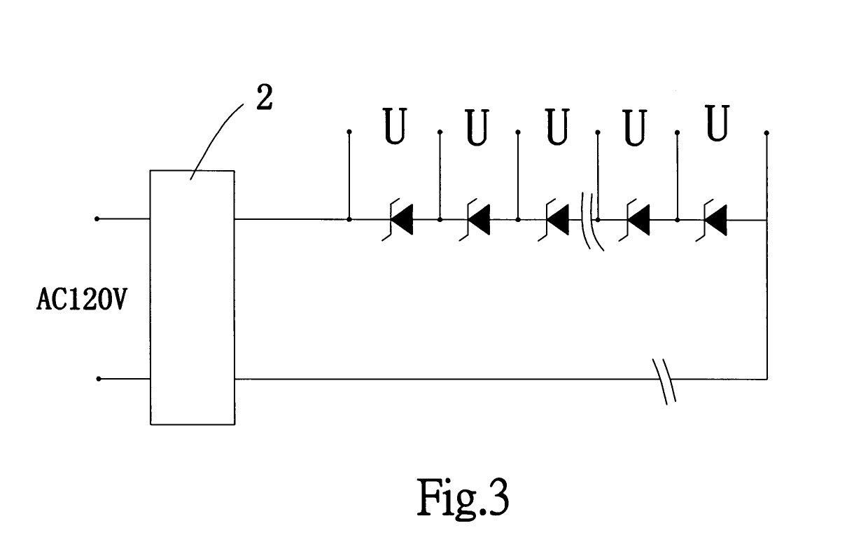

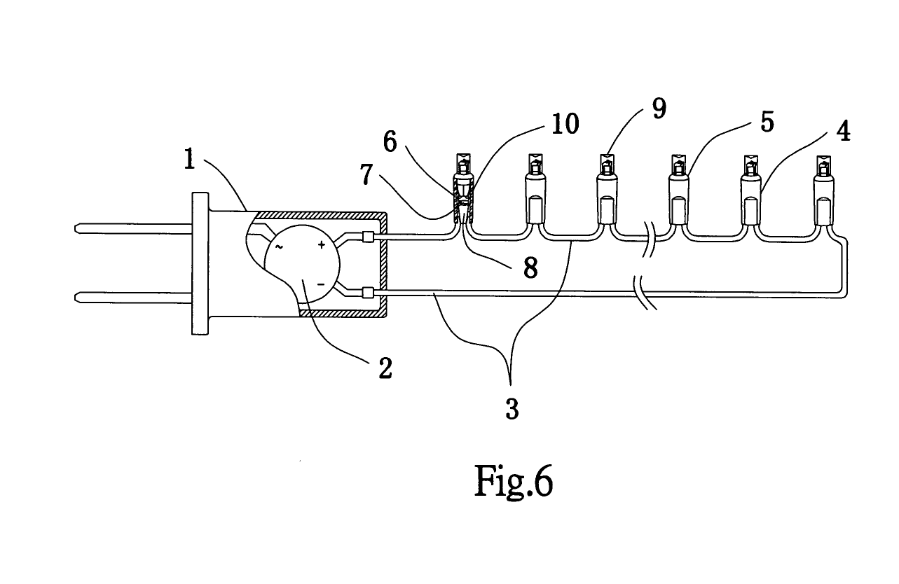

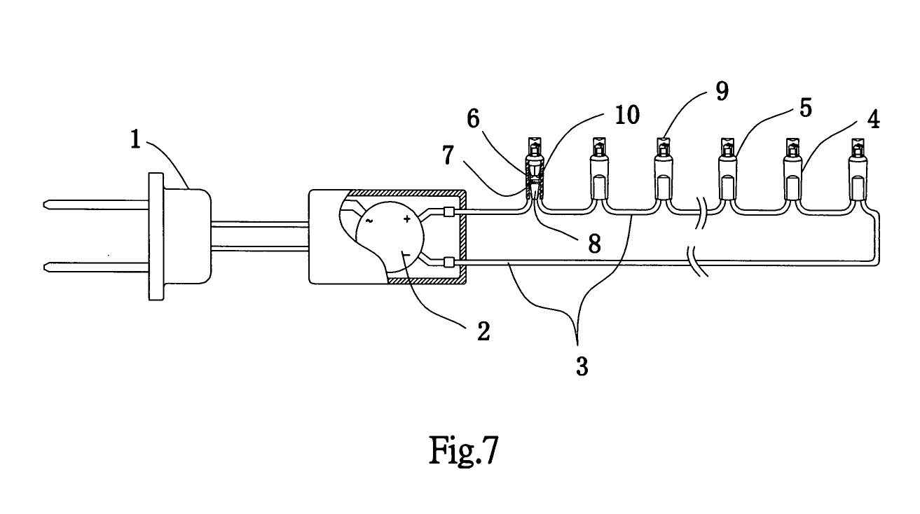

Referring to FIGS. 3, 6, and 7, a string of lights according to the invention is shown. As shown, AC input is AC 120V and the string of lights comprises a plurality of lamps U. Further, the string of lights comprises a plug 1 and a full-wave rectifier 2 which is either mounted inside the plug 1 (see FIG. 6) or formed separately from the plug 1 (see FIG. 7). Waveshape of the rectifier output is more smooth due to the provision of capacitors as discussed later.

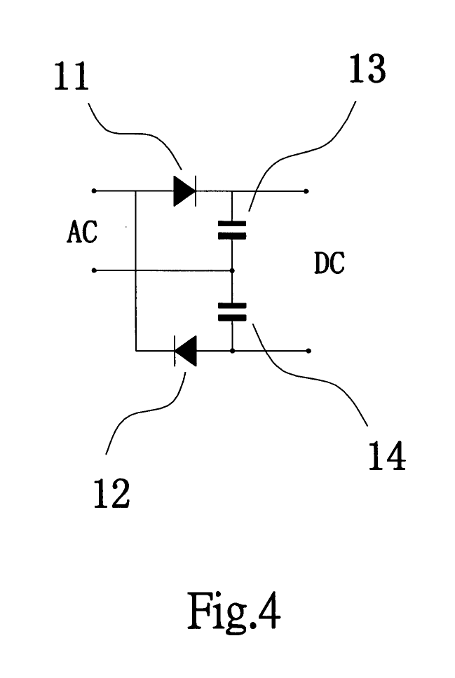

Referring to FIG. 4, a first preferred embodiment of rectifier according to the invention is shown. The rectifier is implemented as a full-wave rectifier and is adapted to convert AC 120V (i.e., AC source) into DC 120V (i.e., operating voltage) to be consumed by a plurality of lamps U of the string of lights. The rectifier comprises a first diode 11 having an anode connected to a positive of AC source, a first capacitor 13 having one end connected to both a cathode of the first diode 11 and one end of the load (i.e., the lamps U), and the other end connected to a negative of the AC source, a second capacitor 14 having one end connected to the negative of the AC source and the other end connected to the other end of the load, and a second diode 12 having an anode connected to the other end of the load and a cathode connected to the anode of the first diode 11.

Preferably, each of a voltage drop across both ends of the first capacitor 13 and a voltage drop across both ends of the second capacitor 14 is to the range of 1.3 to 1.42 times as compared with the output voltage of a full-wave rectifier without filter. Further, the output voltage of the rectifier is an addition of the voltage drop across both ends of the first capacitor 13 and the voltage drop across both ends of the second capacitor 14. That is, the output voltage of the rectifier is increased to the range of 2.6 to 2.84 times as compared with the output voltage of a full-wave rectifier without filter so that an increased number of lamps U can be attached to the string of light as detailed later.

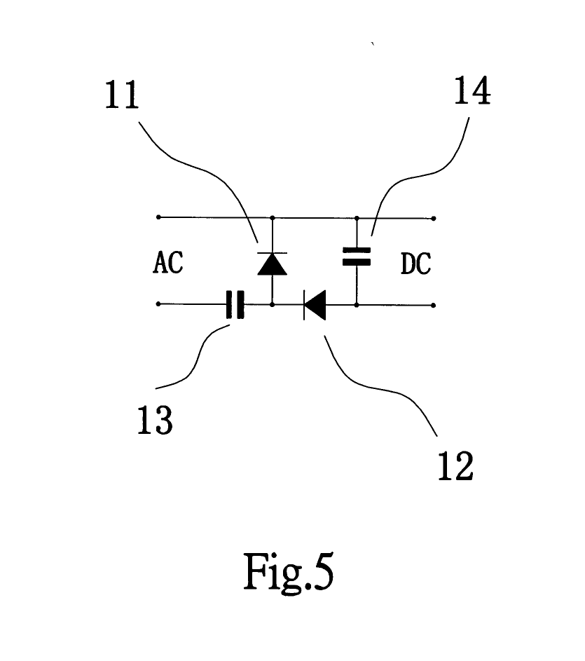

Referring to FIG. 5, a second preferred embodiment of rectifier according to the invention is shown. The rectifier is implemented as a full-wave rectifier and is adapted to convert AC 120V (i.e., AC source) into DC 120V (i.e., operating voltage) to be consumed by a plurality of lamps U of the string of lights. The rectifier comprises a first diode 11 having a cathode connected to a positive of the AC source, a first capacitor 13 having one end connected to an anode of the first diode 11 and the other end connected to a negative of the AC source, a second capacitor 14 having one end connected to both the positive of the AC source and one end of the load, and the other end connected to the other end of the load, and a second diode 12 having an anode connected to the other end of the load and the other end of the second capacitor 14, and a cathode connected to both the anode of the first diode 11 and one end of the first capacitor 13.

Preferably, each of a voltage drop across both ends of the first capacitor 13 and a voltage drop across both ends of the second capacitor 14 is to the range of 1.3 to 1.42 times as compared with the output voltage of a full-wave rectifier without filter. Further, the output voltage of the rectifier is an addition of the voltage drop across both ends of the first capacitor 13 and the voltage drop across both ends of the second capacitor 14. That is, the output voltage of the rectifier is increased to the range of 2.6 to 2.84 times as compared with the output voltage of a full-wave rectifier without filter so that an increased number of lamps U can be attached to the string of light as detailed later.

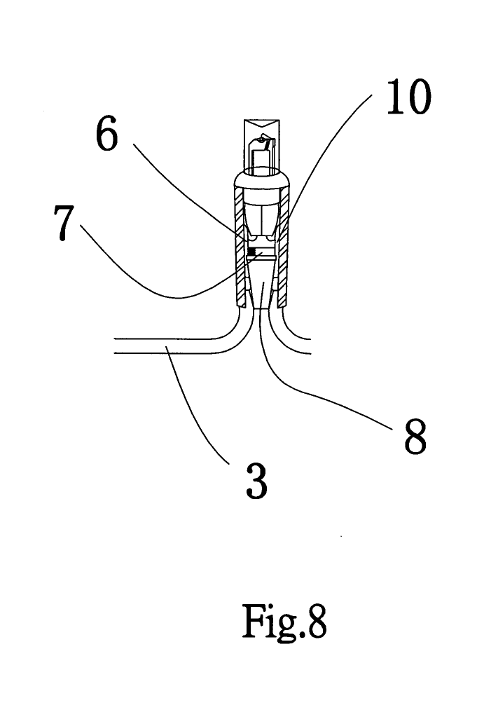

Referring to FIG. 8 in conjunction with FIG. 7, the light string comprises a plug 1 having positive and negative prongs (not numbered), a rectifier 2 as any one shown above, and a plurality of lamps 4 electrically connected together between positive terminal of the rectifier 2 and negative terminal thereof through a cord 3 to construct a complete circuit. Each lamp 4 comprises a seat 8, a first contact 6 connected to one end of a section of the cord 3, a second contact 10 connected to one end of another section of the cord 3, a Zener diode 7 secured onto the seat 8 and interconnecting the contacts 6, 10, a top cap 5 formed of flexible material, and an exposed LED 9 secured onto the cap 5 and interconnecting the contacts 6, 10.

The cathode of the Zener diode 7 of the lamp 4 proximate the rectifier 2 is connected to the positive terminal of the rectifier output and the anode of the Zener diode 7 of the lamp 4 distal the rectifier 2 is connected to the negative terminal of the rectifier output. The LED 9 is in parallel with the Zener diode 7 with the anode of the Zener diode 7 connected to the cathode of the LED 9 and the cathode of the Zener diode 7 connected to the anode of the LED 9. For the circuit, the Zener diodes 7 are connected in series and the LEDs 9 also are connected in series.

The Zener diode 7 of the lamp 4 is used as a voltage stabilizer for the LED 9 thereof. Hence, only low current in a safe range flows through the LEDs 9. As a result, the LEDs 2 can operate normally for a prolonged period of time. Hence, the life time of the light string is prolonged greatly.

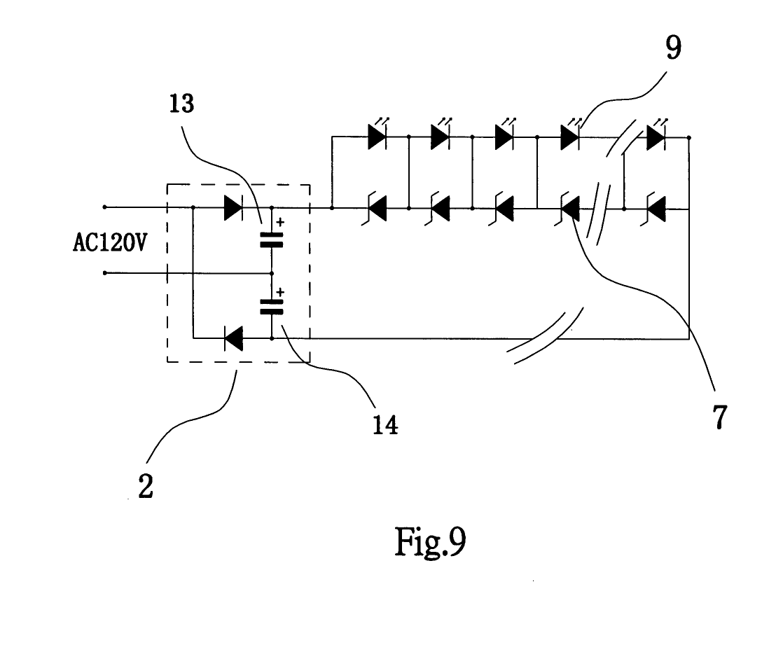

Referring to FIG. 9, it shows a circuit diagram of the string of lights incorporating the first preferred embodiment of rectifier 2 according to the invention. The load of the circuit (i.e., the string of lights), i.e., the plurality of LEDs 9 and the plurality of Zener diodes 7 arranged as above, is coupled to the rectifier output. The rectifier 2 is adapted to convert AC 120V into DC 120V. In this embodiment, the Zener diode 7 has a breakdown voltage of 5V in the reverse direction. Breakdown voltage of 5V is equal to or larger than an operating voltage of LED 9. The LEDs 9 are adapted to emit white light and have an operating current of 0.02 A. Advantageously, the current will bypass any burned out LED 9 to flow through its parallel Zener diode 7 (i.e., shunt). Hence, the circuit still maintain in a normal operation.

As stated in the discussion of FIG. 4, the output voltage of the rectifier 2 is increased to the range of 2.6 to 2.84 times (i.e., in the range of 312 DCV (i.e., 120 DCV×2.6) to 340.8 DCV (i.e., 120 DCV×2.84) as compared with the output voltage of a full-wave rectifier without filter. Therefore, as many as 62 (i.e., 5×62=310 which is less than 312) LEDs 9 can be attached to the string of lights.

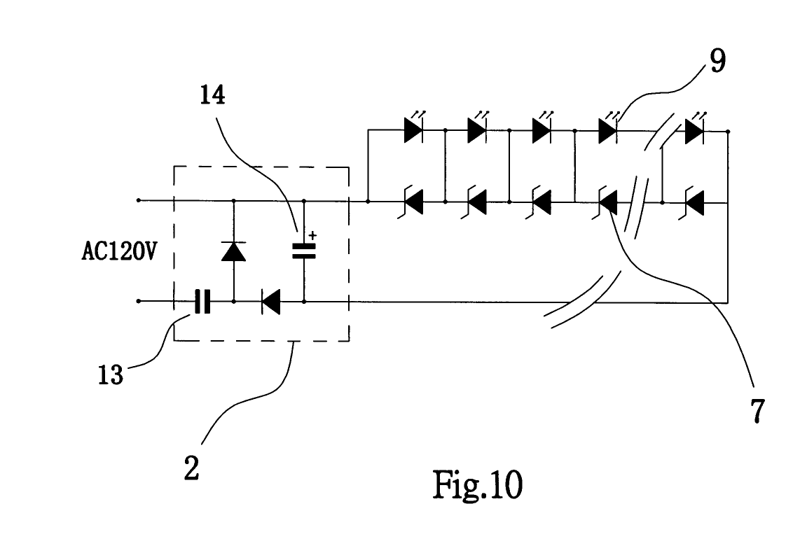

Referring to FIG. 10, it shows a circuit diagram of the string of lights incorporating the second preferred embodiment of rectifier according to the invention. The characteristics of the second preferred embodiment are detailed below. The Zener diode 7 has a breakdown voltage of 8V in the reverse direction. Breakdown voltage of 8V is equal to or larger than an operating voltage of LED 9. The LEDs 9 are adapted to emit blue light and have an operating current of 0.02 A. Advantageously, the current will bypass any burned out LED 9 to flow through its parallel Zener diode 7 (i.e., shunt). Hence, the circuit still maintain in a normal operation.

As stated in the discussion of FIG. 5, the output voltage of the rectifier 2 is increased to the range of 2.6 to 2.84 times (i.e., in the range of 312 DCV (i.e., 120 DCV×2.6) to 340.8 DCV (i.e., 120 DCV×2.84) as compared with the output voltage of a full-wave rectifier without filter. Therefore, as many as 39 (i.e., 8×39=312 which is equal to 312) LEDs 9 can be attached to the string of lights.

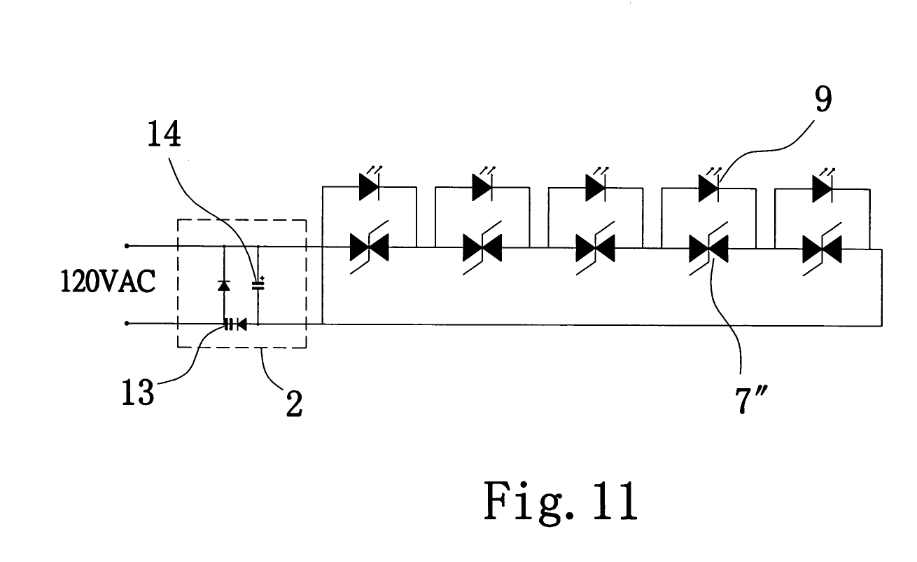

Referring to FIG. 11, it shows a schematic circuit diagram of another string of lights according to the invention. The Zener diodes 7 discussed above are one directional ones (i.e., forward biased ones). It is possible of replacing Zener diodes 7 with a plurality of two-directional Zener diodes 7″ which are electrically connected in series. Each LED 9 is electrically connected in parallel with a corresponding Zener diode 7″. Moreover, some or all of the LEDs 9 may be flash type LEDs.

While the invention herein disclosed has been described by means of specific embodiments, numerous modifications and variations could be made thereto by those skilled in the art without departing from the scope and spirit of the invention set forth in the claims.

What is claimed is:

1. An electrical circuit for use as a string of lights, comprising:
a load comprising a plurality of lamps connected in series, the lamp comprising an LED and a Zener diode in parallel therewith; and
a full-wave rectifier for converting a source of AC (alternating current) into DC (direct current),
wherein the rectifier comprises a first diode having an anode connected to a positive of the source of AC, a first capacitor having one end connected to both a cathode of the first diode and one end of the load, and the other end connected to a negative of the source of AC, a second capacitor having one end connected to the negative of the source of AC and the other end connected to the other end of the load, and a second diode having an anode connected to the other end of the load and a cathode connected to the anode of the first diode.

2. The electrical circuit of claim 1, wherein each of a voltage drop across both ends of the first capacitor and a voltage drop across both ends of the second capacitor is about 1.3 to 1.42 times of an output voltage of a full-wave rectifier without filter; and an output voltage of the rectifier is an addition of the voltage drop across both ends of the first capacitor and the voltage drop across both ends of the second capacitor.

3. An electrical circuit for use as a string of lights, comprising:
a load comprising a plurality of lamps connected in series, the lamp comprising an LED and a Zener diode in parallel therewith; and
a full-wave rectifier for converting a source of AC (alternating current) into DC (direct current),
wherein the rectifier comprises a first diode having a cathode connected to a positive of the AC source, a first capacitor having one end connected to an anode of the first diode and the other end connected to a negative of the AC source, a second capacitor having one end connected to both the positive of the AC source and one end of the load, and the other end connected to the other end of the load, and a second diode having an anode connected to the other end of the load and the other end of the second capacitor, and a cathode connected to both the anode of the first diode and one end of the first capacitor.

4. The electrical circuit of claim 3, wherein each of a voltage drop across both ends of the first capacitor and a voltage drop across both ends of the second capacitor is about 1.3 to 1.42 times of an output voltage of a full-wave rectifier without filter; and an output voltage of the rectifier is an addition of the voltage drop across both ends of the first capacitor and the voltage drop across both ends of the second capacitor.

5. An electrical circuit for use as a string of lights, comprising:
a full-wave rectifier for converting a source of AC (alternating current) into DC (direct current); and
a load powered by the full-wave rectifier and comprising a plurality of Zener diodes connected in series and a plurality of LEDs each connected in parallel with one of the Zener diodes wherein the Zener diodes are two-directional Zener diodes.

6. The electrical circuit of claim 5, wherein the LEDs comprise a plurality of first LEDs adapted to flash.
